(19) United States
(12) Patent Application Publication
(10) Pub. No.: US 2022/0278568 A1
(43) Pub. Date: Sep. 1, 2022

(54) FABRICATION OF SYNCHRONOUS RELUCTANCE MACHINES USING ADDITIVE MANUFACTURING

(71) Applicant: NATIONAL RESEARCH COUNCIL OF CANADA, Ottawa (CA)

(72) Inventors: Maged IBRAHIM, Verdun (CA); Fabrice BERNIER, Montreal (CA); Jean-Michel LAMARRE, Boucherville (CA)

(21) Appl. No.: 17/753,069

(22) PCT Filed: Aug. 6, 2020
(86) PCT No.: PCT/CA2020/051074

§ 371 Date: Feb. 17, 2022

Related U.S. Application Data
(60) Provisional application No. 62/890,110, filed on Aug. 22, 2019.

(51) Int. Cl. H02K 1/24; B22F 10/43; B22F 12/53; B22F 10/66; B33Y 10/00; B33Y 40/20; B33Y 70/00; B33Y 80/00

(52) U.S. Cl. CPC H02K 1/246; B22F 10/43; B22F 12/53; B22F 10/66; B33Y 10/00; B33Y 40/20; B33Y 70/00; B33Y 80/00

(57) ABSTRACT

According to an aspect, a rotor for a Synchronous Reluctance Motor (SynRM) is provided. The rotor core includes alternating layers of radially fabricated flux carrier and flux barrier material, defining flux barriers extending through the core without bridges and/or center-posts. In some embodiments, the alternating layers include layers of permanent magnet (PM) and soft magnetic composite (SMC) material fabricated on, and adhered directly to, the rotor shaft. A corresponding method for manufacturing the SynRM is also provided.

### TECHNICAL FIELD

The technical field generally relates to synchronous reluctance machines, and more particularly to methods for manufacturing components thereof.

### BACKGROUND

Permanent Magnet Synchronous Machines (PMSMs) with rare-earth magnets are utilized in various applications ranging from house appliances to electric vehicles and wind generators, as they can provide high efficiency and torque density. Due to an increase in rare-earth prices, the electric motor industry is looking for alternative designs and technologies that reduce the dependency on rare-earth elements without sacrificing motor performance. The Synchronous Reluctance Motor (SynRM) is considered a promising alternative to PMSMs, due to its robust rotor design and its comparable performance to conventional induction motors. While SynRMs can achieve power density and efficiency comparable to induction motors, their performance is still inferior to PMSMs with rare-earth magnets. There is therefore room for improvement.

### SUMMARY

According to an aspect, a rotor for a Synchronous Reluctance Motor (SynRM) is provided. The rotor includes: a shaft; and a core fixed relative to the shaft. The core includes alternating layers of radially fabricated flux carrier and flux barrier material, defining flux barriers extending through the core without bridges and/or center-posts. In an embodiment, the alternating layers include layers of permanent magnet (PM) and soft magnetic composite (SMC) material fabricated on, and adhered directly to, the rotor shaft.

According to an aspect, a method for manufacturing a rotor for a SynRM is provided. The method includes the steps of: a) providing a support structure; b) fabricating a first layer of flux carrier material on the support structure; c) fabricating a layer of flux barrier material over the first layer of flux carrier material, to define a flux barrier; d) fabricating a subsequent layer of flux carrier material over the layer of flux barrier material; and e) repeating steps c) and d) to form the rotor with a desired number of flux barriers. In an embodiment, the layers are formed by fabricating PM and SMC material using cold spray additive manufacturing.

### BRIEF DESCRIPTION OF THE DRAWINGS

FIG. 1 is a cross-sectional view of a quadrant of traditional SynRM motor according to an exemplary embodiment.

FIG. 2 is a graph illustrating the effect of bridges and center-posts on the performance of SynRM motors.

FIG. 3 is a cross-sectional view of a quadrant of a segmented rotor, according to an exemplary embodiment.

FIG. 4 is a cross-sectional view of a quadrant of a PM-assisted rotor, according to an exemplary embodiment.

FIG. 5 is a cross-sectional view of a quadrant of an alternate SynRM motor, according to an embodiment comprising an axially layered rotor.

FIG. 6 is a cross-section view of a quadrant of an axially layered rotor, according to an embodiment, showing parameters for defining flux barrier structures.

FIG. 7 is a graph showing exemplary results for the optimization of the rotor parameters shown in FIG. 6.

FIG. 8 is a cross-sectional view of an alternate SynRM motor, according to an embodiment comprising 8 poles.

FIG. 9 is a cross-section view of a quadrant of an axially layered rotor, according to an alternate embodiment having notches defined at the rotor surface.

### DETAILED DESCRIPTION

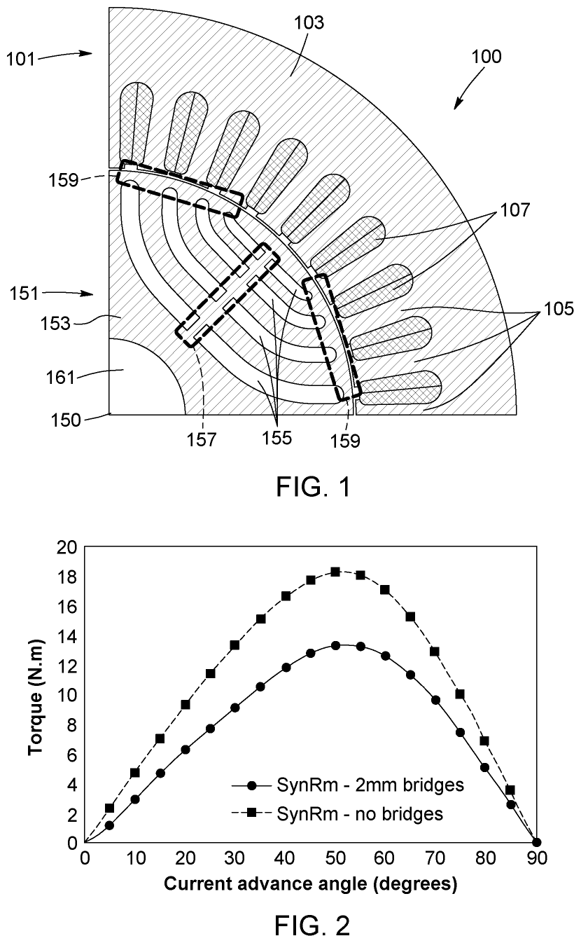

With reference to FIG. 1, a transverse cross section of a typical SynRM motor 100 is shown, including a stator portion 101 and a rotor portion 151. The stator portion 101 comprises a stator core 103 made of a high magnetic permeability material and comprises a plurality of teeth 105 with armature coils 107 wound therearound for generating magnetic fields and defining a plurality of stator poles. The rotor portion 151 is positioned to rotate within the stator portion 101 about a central axis 150 on a rotor shaft 161, in response to the magnetic fields generated by stator portion 101. The rotor shaft 161 extends along a longitudinal axis corresponding to the central axis 150.

The rotor portion 151 comprises a rotor core 153 made of a high magnetic permeability material and comprises a plurality of flux barriers 155 made of non-magnetic material for defining magnetic flux paths through the rotor core 153. In the present illustration, the flux barriers 155 are arc-shaped air gaps defined in the rotor core 153, extending between opposite radial extremities of the rotor core 153. The rotor core 153 is transversally laminated in that it is formed by stacking a plurality of laminations along the longitudinal axis of rotor shaft 161, with each lamination extending in a plane transverse relative to the longitudinal axis of rotor shaft 161. Each of the laminations are substantially identical, and the flux barriers 155 are carved out into each lamination. In such a configuration, to facilitate assembly and maintain structural integrity of the rotor core 153, center-posts 157 and bridges 159 are provided. The center-posts 157 comprise a portion of the rotor core material intersecting the air gaps of the flux barriers 155, and the bridges 159 comprise a portion of the rotor core material spacing the air gaps of the flux barriers 155 apart from the radial extremities of the rotor core 153. As can be appreciated, the posts/bridges 157, 159 can allow for the components of each lamination to be held together as a single piece, thereby facilitating assembly. Moreover, the assembled laminations will have increased structural integrity, which is especially required when the rotor core 153 is operating at high speeds.

Although the center-posts 157 and bridges 159 facilitate assembly and provide additional structural integrity, they can have a significant impact on the performance of the SynRM motor 100. As can be appreciated, the center-posts 157 and bridges 159 increase leakage flux through the flux barriers 155 and lead to a reduction in the motor's torque capability. As show in FIG. 2, Finite Element Analysis (FEA) reveals that removal of bridges/center-posts has the potential of increasing output torque by about 35% compared to a SynRM motor having 2 mm bridges/center-posts. The effect is more pronounced where thicker bridges/center-posts are required.

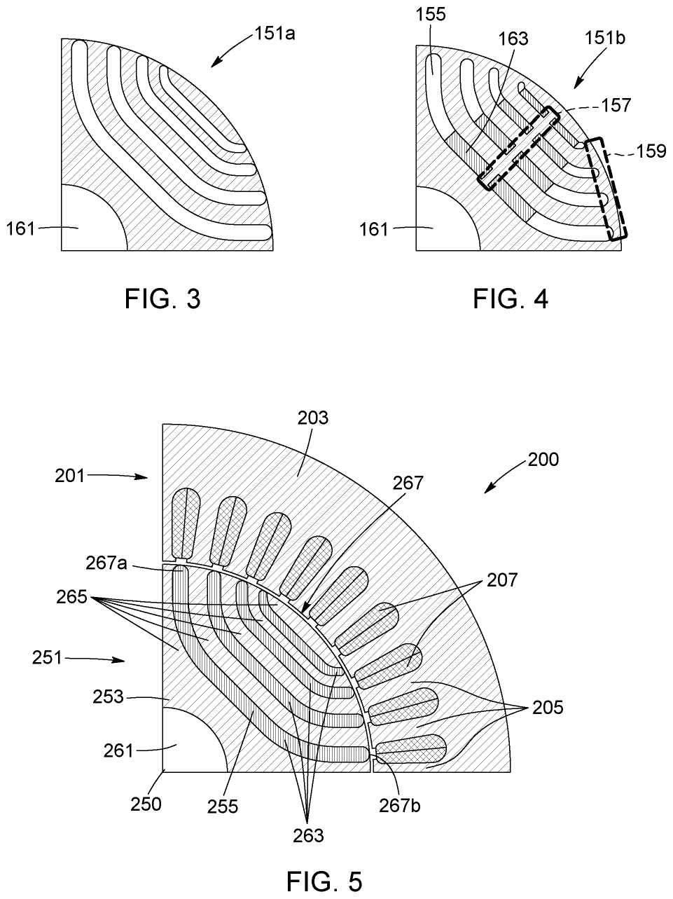

One way to counteract this effect is to provide a rotor core without bridges and/or center-posts, for example as shown in the segmented rotor core 151a of FIG. 3. This can be accomplished, for example, via axial lamination (i.e. providing laminations which extend along axes parallel to the longitudinal axis of rotor shaft, stacking the laminations radially relative to the rotor shaft 161, and bonding the stacked laminations to the rotor shaft 161). It is appreciated, however, that eliminating the bridges/center-posts in this fashion would result in each rotor lamination being divided into numerous non-identical segments, making the assembly process complex and inconvenient for mass production. Another way to counteract the effect of the bridges/center-posts is to insert permanent magnets 163 into the flux barriers 155, for example as shown in the permanent magnet (PM) assisted rotor core 151b of FIG. 4. The permanent magnets 163 can elevate flux density levels in the area of the bridges/center-posts 157, 159, thus increasing the reluctance of the leakage flux path. However, the magnet flux contributing to torque production is relatively low, as a considerable portion of the overall magnet flux circulates in the rotor core saturating the bridges and center-posts.

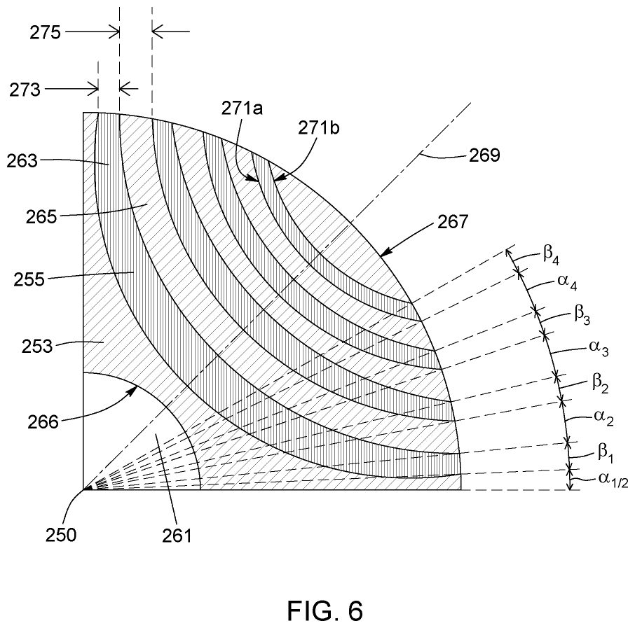

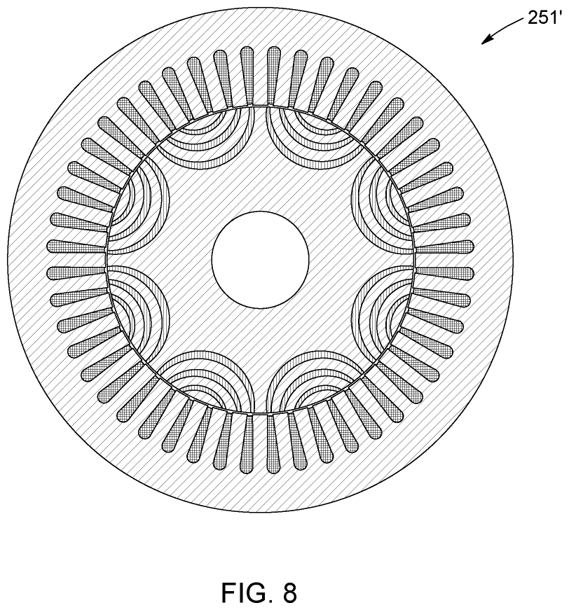

With reference now to FIGS. 5 and 6, an alternate SynRM motor 200 design is shown according to possible embodiments, including a stator portion 201 and a rotor portion 251 configured without center-posts and/or bridges. The stator portion 201 comprises a stator core 203 made of a high magnetic permeability material and comprises a plurality of teeth 205 with armature coils 207 wound therearound for generating magnetic fields and defining a plurality of stator poles. The rotor portion 251 is positioned to rotate within the stator portion 201 about a central axis 250 on rotor shaft 261, in response to the magnetic fields generated by stator portion 201. The rotor shaft 261 extends along a longitudinal axis corresponding to the central axis 150. In the illustrated embodiments, one quadrant of a four-pole rotor 251 is shown. It is appreciated that the other quadrants can be configured in a similar manner. It is also appreciated that a similar design can be provided for rotors having more poles, such as the 8-pole configuration in the motor 200 of FIG. 8.

Referring back to FIGS. 5 and 6, the rotor portion 251 comprises a rotor core 253 made of a high magnetic permeability material and comprises a plurality of flux barriers 255 for defining magnetic flux paths through the core 253. In the present embodiment, the flux barriers 255 are substantially arc-shaped and extend between two points of the rotor surface 267, specifically between first 267a and second 267b spaced-apart radial extremities of the rotor core 253, substantially symmetrically about a symmetry axis 269. It is appreciated, however, that other shapes and configurations of the flux barriers 255 are also possible.

The rotor core 253 is axially layered in that it comprises a plurality of layers which each extend along axes substantially parallel to the longitudinal axis of shaft 261. In particular, the rotor core 253 is formed via alternating layers of flux carrier material 265 (i.e. core material) and flux barrier material 263. The layers 263, 265 alternate along a radial direction relative to the shaft 261. The flux carrier material 265 can comprise a substantially high magnetic permeability material, for example having a relative permeability much greater than 1, and preferably greater than 100. In the present embodiment, the flux carrier material 265 comprises a soft magnetic composite (SMC), but it is appreciated that other similar materials are possible in other embodiments, such as soft magnetic materials. The flux barrier material 263, on the other hand, can comprise a substantially low magnetic permeability material, for example having a relative permeability lower than 100, and preferably close to 1. In the present embodiment, the flux barrier material 263 comprises a permanent magnet material, but it is appreciated that in other embodiments, the flux barrier material 263 can comprise a non-magnetic material and/or a combination of magnetic and non-magnetic materials.

The layers of rotor core 253 are arranged to prevent leakage flux between the magnetic flux paths defined by the flux barriers 255. More specifically, in the present embodiment, the layers of flux carrier material 265 are completely separated from one another via a corresponding layer of flux barrier material 263. In other words, each layer of flux barrier material 263 extends continuously and uninterrupted along a thickness 273, between an outer radial boundary 271a of a first flux carrier layer, and an inner radial boundary 271b of a second flux carrier layer. In such a configuration, substantially no flux carrier material 265 extends within or through the layers of flux barrier material 263.

In the present embodiment, the layers of rotor core 253 are also configured such that the rotor core 253 is a substantially solid mass. In other words, there are no air gaps or pockets between inner 266 and outer 267 surfaces of the rotor core 253, and adjacent layers of flux carrier material 265 and flux barrier material 263 are contiguous and fully adhered to one another along their boundaries. In this fashion, the rotor core 253 essentially consists of a solid mass comprising complex shaped magnets embedded in a soft magnetic material.

As can be appreciated, various geometric properties of the layers can be adjusted depending on the requirements of the rotor portion 251. For example, the flux barrier layer thickness 273 and flux carrier layers thickness 275 can vary from one embodiment to another. In some embodiments, for example as shown in FIG. 5, each flux barrier layer can have the same or similar thickness 273, and/or each flux barrier layers can be spaced apart by the same distance (i.e. be separated by flux carrier layers having the same or similar thickness 275). In other embodiments, for example as shown in FIG. 6, each flux barrier layer can have a different thickness 273 and/or can be spaced apart from one another by different distances or flux carrier thickness 275. In some embodiments, for example as shown in FIG. 5, the thicknesses 263, 275 can be relatively uniform, for example resulting in flux barriers 255 having a substantially uniform thickness along their paths between first 267a and second 267b radial extremities of the rotor core 253. In other embodiments, for example as shown in FIG. 6, the thicknesses 263, 275 can vary across a given layer, for example resulting in flux barriers 255 having a thickness which varies along its path between first 267a and second 267b radial extremities of the rotor core 253. Moreover, it is appreciated that the number of layers of flux barrier material 263 and flux carrier material 265 can vary. For example, in the embodiments of FIGS. 5 and 6, there are four layers of flux barrier material 263. In other embodiments, more or fewer layers of flux barrier material 263 can be provided, depending on the desired number of flux barriers 255.

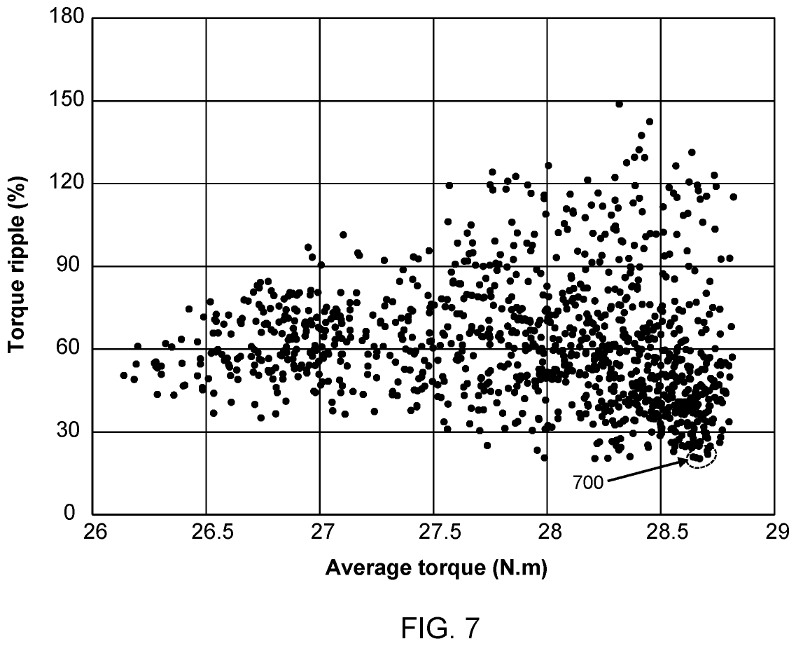

It is further appreciated that the geometric properties can be adjusted to optimize performance parameters of the rotor 251. In the embodiment shown in FIG. 6, the flux barrier and flux carrier layers are each configured as substantially concentric arcs, extending between first 267a and second 267b spaced-apart radial extremities of the rotor core 253, symmetrically about axis 269. The angles α1 to α4 define the flux carrier angles at the rotor surface 267, while the angles β1 to β4 define the flux barrier angles at the rotor surface 267. As can be appreciated, individually adjusting angles α1 to α4 and β1 to β4 will result in different rotor geometries which may have different properties. Accordingly, these eight parameters can be optimized to obtain the desired performance characteristics. For example, in the results shown in FIG. 7, a genetic algorithm was applied to optimize the eight parameters with an objective function aiming to minimize torque ripple and maximize average torque. During the optimization procedure, 1399 candidate designs were evaluated and simulated, resulting in designs 700 which converge towards low torque tipple and high average torque. One of the designs could then be selected for production, for example by choosing the design with the lowest torque ripple and maximum average torque. However, other factors can also be taken into account when choosing the optimal design, such as low magnet volume and/or low risk of demagnetization. It is appreciated that different optimization algorithms could be used to generate a desired design, and that different performance parameters can be sought. It is further appreciated that a similar optimization process can be carried out for different flux barrier configurations and using different optimization parameters.

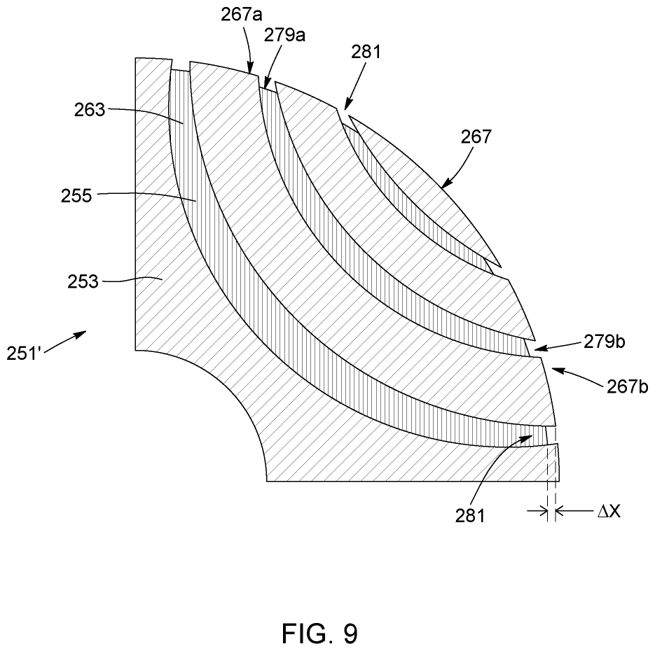

Although in the above-described embodiments the flux barriers 255 extend up to the rotor surface 267 (specifically between the first 267a and second 267b radial extremities of the rotor core 253), it is appreciated that other configurations are possible. For example, with reference to FIG. 9, an alternate configuration of rotor 251′ is shown. In the illustrated configuration, the flux barriers 255 extend between first 279a and second 279b extremities that are spaced apart radially inward from rotor surface 267 by a distance ΔX. In this fashion, small gaps or notches 281 are defined at the rotor surface 267 adjacent the extremities 279a, 279b of the flux barriers (i.e. at first 267a and second 267b extremities of rotor surface). In the present embodiment, the notches 281 are air notches, although it is appreciated that they can be filled with any suitable non-conductive material. As can be appreciated, magnets located in close proximity to the armature may be more vulnerable to irreversible demagnetization. Accordingly, providing the notches 281 at the extremities of the flux barriers 255 at the rotor surface 267 can help prevent demagnetization of the flux barrier material 263. This can help with the stability of the rotor performance under different operation conditions. It can also lead to a reduction of the magnet eddy current losses and thus improve the overall motor efficiency.

As can be appreciated, the above-described axially layered rotor core 253 can have good magnetic, and mechanical properties. However, it can also be suitable for mass manufacturing, as it can be fabricated using different additive manufacturing techniques which involve fabricating layers of flux carrier material and flux barrier material in an alternating fashion to obtain a final structure. For example, and with reference to FIGS. 5, 6 and 9, a method of manufacturing an axially layered rotor core 253 can include the steps of: a) providing a support structure; b) fabricating a first layer of flux carrier material 265 on the support structure; c) fabricating a layer of flux barrier material 263 over the previous layer of flux carrier material 265, to define a flux barrier 255; d) fabricating a subsequent layer of flux carrier material 265 over the layer of flux barrier material 263; and e) repeating steps c) and d) to form rotor core 253 with a desired number of flux barriers 255. The manufactured rotor core 253 can then be bonded or secured to a rotor shaft 261 and/or otherwise installed relative to a stator 101 to form a motor 200. In some embodiments, fabricating the layers of flux barrier and/or flux carrier material can comprise depositing the flux barrier and/or flux carrier material on the support structure and/or over a previous layer of flux barrier and/or flux carrier material. In some embodiments, the first layer of flux carrier material 265 can be deposited, formed or otherwise fabricated directly on the support structure, with subsequent layers of flux carrier 265 and/ flux barrier 263 materials deposited, formed or fabricated thereon. In some embodiments, in step c), the flux barrier material 263 can be deposited over the flux carrier material 265 such that it completely covers the previous layer of flux carrier material 265 without leaving any air gaps within the body of rotor core 253. In some embodiments, in step c), the flux barrier material 263 can be deposited over the flux carrier material 265 such that it completely covers the previous layer of flux carrier material 265 between first 267a and second 267b radial extremities of rotor core 253. In other embodiment, in step c), the flux barrier material 263 can be deposited over the flux carrier material 265 between first 279a and second 279b extremities spaced radially inward from first 267a and second 267b extremities of rotor core 253 by a distance ΔX, thereby defining notches 281 at the rotor surface 267. In some embodiments, a subsequent step f) can include machining the layered rotor core 253 for balancing and/or to refine the rotor surface 267 (for example to define notches 281 by removing at least some flux barrier material 263) or to refine the shaft interface, for example to achieve a desired finish and/or assure a proper fit with the stator 201. In some embodiments, the support structure can correspond to the rotor shaft 261. Accordingly, in such embodiments, the first layer can be fabricated, deposited, or formed directly on the rotor shaft 261.

In the present embodiment, the flux barrier material 263 is a magnetic material. When the layers of flux barrier material 263 are fabricated in step c), the material 263 is not in a magnetized state. Accordingly, an additional step can comprise magnetizing the flux barrier material 263. In the present embodiment, the step of magnetizing the barrier material 263 is carried our after step e) (i.e. after rotor assembly). However, it is appreciated that in other embodiments, magnetization can be done at any time after fabricating one or more layers of the barrier material 263. Magnetizing the flux barrier material 263 can comprise applying a magnetic field to the one or more layers of flux barrier material 263. As can be appreciated, the required magnetization of the flux barriers 255 can vary based on the rotor configuration and materials used, and different magnetic field strengths can be required to fully magnetize all flux barrier layers. In the present embodiment, the flux barriers 255 are magnetized by the armature coils 207 of stator 201. More specifically, motor 200 is a 3-phase motor, and magnetization is carried out by applying a current through two phases of the armature coils 207 (phase A and phase B), with the direct axis (d-axis) of the rotor aligned with the armature magnetic field. A current of at least 2,000 A is applied to the armature coils 207 to generate a magnetic field of at least 1,000 kA/m and 1,300 kA/m in each of the flux barriers 255, thereby fully magnetizing the flux barrier material 263. It is appreciated, however, that different currents can be used in different rotor and/or stator winding configurations. Moreover, in some embodiments, the flux barrier material 263 can be magnetized by other sources of magnetic fields.

Different additive manufacturing techniques can be used in order to build the rotor core 253, for example by radially fabricating layers of flux barrier 263 and flux carrier 265 materials relative to the central axis 250 and/or rotor shaft 261. In other words, each layer can be deposited, formed, or fabricated such that it is built up in a radial direction relative to central axis 250 and/or rotor shaft 261. Once a desired thickness of a given layer is achieved, a subsequent layer of different material can be deposited, formed or fabricated thereon. In this fashion, the layers 263, 265 of the rotor core 253 will alternate along a radial direction relative to central axis 250 and/or rotor shaft 261. As can be appreciated, when building the layers radially, each layer 263, 265 can be deposited, formed, or fabricated along a length of the central axis 250 and/or rotor shaft 261, and about a circumference thereof. In this fashion, the radially formed layers can be described as axial layers, in that they extend along an axis substantially parallel to the central axis 250 and/or longitudinal axis of rotor shaft 261.

As can be appreciated, additive manufacturing allows for complex structures to be formed within the core 253, whereas traditional manufacturing technologies would limit rotor structures to simple shapes. Moreover, forming the core in this manner allows the flux carrier 265 layers (for example fabricated using SMC) to accept 3D magnetic flux, and thus accept flux in any direction. This is as opposed to traditional laminations which accept flux only in the plane of the laminations. In the present embodiment, cold spray manufacturing is used to deposit alternating layers of flux barrier material 263 and flux carrier material 265, respectively comprising permanent magnet (PM) and soft magnetic composite (SMC) material. It is appreciated, however, that any type of additive manufacturing technique which allows for building layers of metallic structures can be used. For example, techniques such as big area additive manufacturing, fused filament fabrication, laser sintering, binder jetting and powder bed manufacturing can be used, among others, in additional to techniques such as molding or pressing. It is further appreciated that different spray-based manufacturing techniques (i.e. any technique which involves the controlled depositing of layers or coats using atomized and/or particulate matter) can be used, such as aerosol spray, High-Velocity Air-Fuel (HVAF), High-Velocity Oxygen-Fuel (HVOF), or other thermal spraying techniques. Moreover, it is appreciated that a combination of different techniques can be used. For example, the first layer of SMC can be pressed directly on the rotor shaft, with subsequent layers built thereon using spray-based manufacturing techniques. Finally, it is appreciated that different combinations of materials can be used, such as compounds of the following families, including any alloys and/or mixtures thereof: a) Permanent magnets: ferrites, Neodymium Iron Boron, Samarium Cobalt, and Aluminum Nickel Cobalt, and b) SMCs: pure Iron, Cobalt Iron, Silicon iron, or any of such materials obtained from a powder coated with a surrounding organic or inorganic insulating layer. A person having ordinary skill in the art would acknowledge that the various properties of these materials can be tailored to the application by the inclusion of other elements.

In the description provided above, exemplary embodiments of a rotor structure and method of manufacturing the same have been provided. It is appreciated that these embodiments are provided for illustrative purposes only and should not be taken so as to limit the scope of the invention. For example, it should be appreciated that minor modifications and substitutions can be made to the above-described configurations without departing from the scope of the invention. It should be further appreciated that the layered structure of the described rotor can be applied to other structures having similar requirements, such as a stator or a differently shaped rotor. Finally, it should be appreciated that although the invention was described in relation to a motor, similar principles and structures can be used in connection with other types of electrical machines.

1. A method of manufacturing a rotor for a Synchronous Reluctance Motor (SynRM), the method comprising:
a) providing a support structure;
b) fabricating a first layer of flux carrier material on the support structure;
c) fabricating a layer of flux barrier material over a previous layer of flux carrier material, to define a flux barrier;
d) fabricating a subsequent layer of flux carrier material over the layer of flux barrier material; and
e) repeating steps c) and d) to form a rotor core with a desired number of flux barriers.

2. The method according to claim 1, wherein the support structure extends along a longitudinal axis, and the layers of flux barrier and flux carrier material are fabricated radially relative to the longitudinal axis of the support structure.

3. The method according to claim 1, wherein in step c), the layer of flux barrier material is fabricated to completely cover the previous layer of flux carrier material between first and second extremities, thereby defining a complete separation between the layers of flux carrier material.

4. The method according to any claim 1, wherein the layer of flux barrier material is fabricated between first and second extremities that are spaced radially inward from an exterior surface of the rotor core.

5. (canceled)

6. The method according to claim 1, wherein the layers of flux barrier and flux carrier material are deposited using spray-based additive manufacturing.

7. (canceled)

8. (canceled)

9. (canceled)

10. (canceled)

11. The method according to claim 1, further comprising a step of machining the rotor core to balance the rotor core or to refine an outer surface of the rotor core.

12. The method according to claim 11, further comprising removing at least some flux barrier material to define notches on the outer surface of the rotor core.

13. The method according to claim 1, further comprising a step of magnetizing the flux barriers.

14. The method according to claim 13, further comprising positioning the rotor within a stator, and magnetizing the flux barriers using windings in the stator.

15. The method according to claim 1, wherein the support structure comprises a rotor shaft, and the first layer of flux carrier material is adhered directly to the rotor shaft.

16. (canceled)

17. (canceled)

18. (canceled)

19. A rotor for a Synchronous Reluctance Motor (SynRM), comprising:
a shaft extending along a longitudinal axis; and
a rotor core fixed relative to the shaft, said rotor core comprising alternating layers of flux barrier and flux carrier material fabricated via additive manufacturing, wherein the alternating layers extend parallel to the longitudinal axis and alternate between flux barrier and flux carrier material along a radial direction relative to the shaft.

20. The rotor according to claim 19, wherein the rotor core comprises a body defined via the flux carrier material, said body comprising a plurality of flux barriers extending therethrough for defining magnetic flux paths, said flux barriers being defined via the flux barrier material.

21. The rotor according to claim 20, wherein the flux barriers extend through the body without bridges or center-posts.

22. The rotor according to claim 19, wherein the layers of flux barrier and flux carrier material together define a substantially solid mass without pockets or air gaps between an inner and an outer surface of the rotor core.

23. The rotor according to claim 19, comprising a plurality of notches defined on an outer surface of the rotor core at extremities of the flux barrier material.

24. The rotor according to claim 19, wherein the layers of flux carrier material are completely separated from one another via a corresponding intermediate layer of flux barrier material.

25. The rotor according to claim 19, wherein each layer of flux barrier material extends uninterrupted along a thickness, between an outer radial boundary of an inner flux carrier layer, and an inner radial boundary of an outer flux carrier layer.

26. (canceled)

27. The rotor according to claim 19, wherein a first layer of flux carrier material is adhered directly to the shaft.

28. (canceled)

29. The rotor according to claim 19, wherein the flux carrier material comprises a SMC material or soft magnetic material.

30. (canceled)

31. The rotor according to claim 19, wherein the flux barrier material comprises a PM material selected from a group consisting of: ferrites, neodymium iron boron, samarium cobalt, aluminum nickel cobalt, alloys thereof, and mixtures thereof.

32. (canceled)
